(19) United States
(12) Patent Application Publication
(10) Pub. No.: US 2021/0070660 A1
(43) Pub. Date: Mar. 11, 2021

(54) ECONOMICAL HIGH-STRENGTH QUICK-HARDENING GROUTING MATERIAL AND GROUTING REINFORCEMENT METHOD FOR SOFT ROCK TUNNEL

(71) Applicant: Chang'an University, Xi'an, ShaanXi Province (CN)

(72) Inventors: Jianxun CHEN, Xi'an, ShaanXi Province (CN); Lijun CHEN, Xi'an, ShaanXi Province (CN); Yanbin LUO, Xi'an, ShaanXi Province (CN); Weiwei LIU, Xi'an, ShaanXi Province (CN); Chuanwu WANG, Xi'an, ShaanXi Province (CN)

(21) Appl. No.: 17/044,675

(22) PCT Filed: Jun. 14, 2019
(86) PCT No.: PCT/CN2019/091241

§ 371 Date: Oct. 1, 2020

(30) Foreign Application Priority Data
Nov. 29, 2018 (CN) 201811441534.2

(51) Int. Cl. C04B 28/06; E21D 11/10

(52) U.S. Cl. CPC C04B 28/06; C04B 2111/00172; E21D 11/107

(57) ABSTRACT

An economical high-strength quick-hardening grouting material includes ordinary Portland cement, a quick-hardening sulphoaluminate gelling agent and water. The ratio of the mass of water to the sum of the mass of the ordinary Portland cement and the mass of quick hardening sulphoaluminate gelling agent is 0.46:1. The ratio of the mass of the quick-hardening sulphoaluminate gelling agent to the mass of the ordinary Portland cement is (0.67-1.5):1. The initial setting time of the grouting reinforcement material is 40±5 min, and the average compressive strength of a cube solidified for 4 hours is higher than or equal to 10 MPa.

### FIELD

The invention belongs to the technical field of building project construction, and relates to an economical high-strength quick-hardening grouting material and a grouting reinforcement method for a soft rock tunnel.

### BACKGROUND

China is already the country with the largest scale, the largest number and the highest construction speed of tunnel engineering in the world. 14040 km/15181 highway tunnels have been built by the end of 2017 and 15781 km/14700 railway tunnels have been built by the end of 2017.

Mountains and continuously undulating hills are the main part of the central and western regions of China, topographic and geological conditions are complex and varied, and thus, development of traffic will inevitably encounter a large number of tunnel projects. With the improvement of tunnel construction standards and scale, safe and efficient crossing of soft rock regions with high ground stress faces great challenges, especially, the large deformation problem of soft rock with high ground stress is prominent when crossing weak, loose and broken rock, and existing tunnel theoretical methods and construction technologies cannot meet the needs of disaster prevention and reduction of projects.

According to different grouting objects and purposes, grouting in a tunnel can be divided into five types including grouting for a collapse body, water-stop grouting for a tunnel, foundation reinforcement grouting, stratum reinforcement grouting, anchor rod grouting and the like. The stratum grouting and anchor rod reinforcement (such as a yielding bolt) are the most effective and common project measures to control large deformation of weak, loose and broken strata. Therefore, the performance of grout is particularly important for tunnel grouting projects. A grouting material is the key to reinforce weak, loose and broken surrounding rocks to form a reinforcement ring and a bearing arch and provide anchoring force for anchor rod. In the design of the grouting project, selection of grout is important and directly affects the quality of grouting and the cost of projects. Due to the different purposes and requirements of grouting, grouts should be selected differently. The conventional grouting material for the tunnel projects is ordinary Portland cement paste, the setting time of the cement paste (in terms of the water-binder ratio of 0.5) is usually longer than 5 h, and the tunnel has been blasted once according to the normal process of the tunnel construction. Due to the poor structural stability of an initial support of the tunnel, settlement deformation often occurs under the action of dead weight and additional load due to blast disturbance, and can reach 100-200 mm/d to a maximum extend, at the moment, cement grout filled around the anchor rod still has little or no strength and bond stress, the anchoring force of the anchor rod, the suspension effect on the initial support and the extrusion reinforcement effect on surrounding rocks cannot be effectively exerted in time, the initial support is separated from surrounding rocks, the overlying rocks lose the restraint effect of support, because the cohesion of soft rocks is quite small, it is difficult to overcome dead weight of the rocks and additional load caused by construction disturbance, thus, the rock mass at the tunnel arch slides and loosens downwards, expansion of a loose area of the tunnel arch is caused, the anchoring force of the anchor rod cannot be effectively exerted in time, the structural stability of the initial support is further deteriorated, the problems of instability and failure of the initial support such as distortion and fracture of a steel frame and cracking of sprayed concrete occur, and large deformation disasters are aggravated. Therefore, prevention and control of tunnels with large deformation are often quite difficult, and effects are difficult to achieve. Grouting materials commonly used for stratum reinforcement and anchor rod reinforcement have the following defects for prevention and treatment of large deformation disasters of tunnels in weak, loose and broken strata:

(1) The early strength of grouting materials is low, the surrounding rocks cannot be reinforced and the anchoring force of the anchor rod cannot be provided in time, and under the action of frequent construction disturbance (especially blasting vibration), the initial support is prone to settlement deformation and is separated from the surrounding rocks, so that the overlying surrounding rocks are dragged to loosen, and a large deformation disaster is induced.

(2) The setting speed of the grout is low, and the grout is easy to dilute and loss under the action of underground water, so that the grouting quality is poor.

(3) The designed water-binder ratio is unreasonable, and excessively thin cement grout with W/C=1:1 is often common.

(4) The in-situ tunnel grouting is inaccurate in proportioning, and for grout with complex grouting materials (especially excessive admixture), omission or repeated addition of a certain admixture is easy to occur, and the process is complex and difficult to popularize and apply.

(5) Little effect is achieved but harm is obvious. As for the soft rock, the ordinary Portland cement paste commonly used in the tunnels does not have proper effects, and has little reinforcing or anchoring effects, furthermore, due to the characteristics of excessively low water-cement ratio, low setting speed and the like, the softening effect of the soft rock is obvious after the soft rock is soaked for a long time, the load from the overlying surrounding rocks of the tunnels is increased, and the softening deformation of the surrounding rocks of the tunnels is aggravated.

Therefore, it is very important to develop grouting materials which are suitable for weak, loose and broken strata, meet the grouting requirements of large deformation tunnels in complex construction environments, and have simple and practical proportioning, high operability and excellent performance.

### SUMMARY

The invention aims to provide an economical high-strength quick-hardening grouting material and a grouting reinforcement method for a soft rock tunnel, and the grouting material has the advantages of high grout setting speed, simplicity in preparation, high strength and quick hardening, and meets rapid construction requirements of the soft rock tunnel.

In order to achieve the above object, the invention adopts the following technical scheme:

an economical high-strength quick-hardening grouting material includes ordinary Portland cement, a quick-hardening sulphoaluminate gelling agent and water, wherein the ratio of the mass of the water to the sum of the mass of the ordinary Portland cement and the mass of the quick-hardening sulphoaluminate gelling agent is 0.46:1, and the ratio of the mass of the quick-hardening sulphoaluminate gelling agent to the mass of the ordinary Portland cement is (0.67-1.5): 1; and the initial setting time of the grouting reinforcement material is 40±5 min, and the average compressive strength of a cube solidified for 4 hours is higher than or equal to 10 MPa.

In the economical high-strength quick-hardening grouting material, the quick-hardening sulphoaluminate gelling agent is quick-hardening sulphoaluminate 425# cement.

In the economical high-strength quick-hardening grouting material, the ratio of the mass of the quick-hardening sulphoaluminate gelling agent to the mass of the ordinary Portland cement is (1-1.5): 1.

In the economical high-strength quick-hardening grouting material, the ratio of the mass of the quick-hardening sulphoaluminate gelling agent to the mass of the ordinary Portland cement is (0.67-1): 1.

In the economical high-strength quick-hardening grouting material, the ratio of the mass of the quick-hardening sulphoaluminate gelling agent to the mass of the ordinary Portland cement is (0.67-0.9): 1.

In the economical high-strength quick-hardening grouting material, the ratio of the mass of the quick-hardening sulphoaluminate gelling agent to the mass of the ordinary Portland cement is 1.5:1.

A grouting reinforcement method for a soft rock tunnel, wherein: including the steps of tunnel excavation of one footage, initially spraying concrete, erecting steel frames, and reinforcing surrounding rocks through advanced grouting small guide pipes, circumferential radial guide pipes and feet-lock pipes, wherein the advanced grouting small guide pipes, the circumferential radial guide pipes and the feet-lock pipes are filled with the economical high-strength quick-hardening grouting material as claimed in any one of claims 1-6; the grouting pressure of the advanced grouting small guide pipes is 1.0-3.0 MPa, the grouting pressure of the circumferential radial guide pipes is 1.5-5.0 MPa, the grouting pressure of the feet-lock pipes is 0.5-1.0 MPa, and short-time long-interval excavation construction is realized.

In the grouting reinforcement method for the soft rock tunnel, a mechanical and/or weak blasting construction method is adopted in excavation of the soft rock tunnel.

Furthermore, for the grouting project of a soft and loose surrounding rock tunnel, the main anchor rod supports can be divided into the supports of the advanced guide pipe, the circumferential radial guide pipe and the feet-lock pipe according to a setting and driving position. The advanced grouting guide pipe, the circumferential radial guide pipe and the feet-lock pipe which are involved in the invention belong to hollow pipe type anchor rod, and the anchoring mode is adhesive anchoring. The grouting pressure parameters are different due to the fact that the anchor rods (pipes) in the soft and loose surrounding rock tunnel have different functions. The advanced grouting guide pipe has a main effect of ensuring the stability of an excavation face by pre-strengthening the surrounding rocks in front of a tunnel face, and the grouting pressure (final pressure) is generally between 1.0 MPa and 3.0 MPa; the circumferential radial grouting guide pipe has main effects of improving the integrity of a rock mass and reinforcing the surrounding rocks through filling the cracks of soft and loose surrounding rocks with the grouting material, the grouting pressure is high, and the final pressure is generally between 1.5 MPa and 5.0 MPa depending on the stratum gap; and the feet-lock pipe has a main effect of controlling settlement of arch feet of a supporting structure, the grouting pressure is small, and the final pressure is generally between 0.5 MPa and 1.0 MPa, namely so that anchor holes and rod bodies can be filled densely.

Furthermore, the main application environment of the grouting material involved in the invention in the field of tunnel projects is a weak, loose, broken and weakly cemented stratum, and is most likely a surrounding rock section which has project disasters such as large deformation and collapse due to tunnel excavation, blasting vibration and construction disturbance. Under above condition of the tunnel stratum, all anchor rod grouting materials are suggested to adopt the high-strength quick-hardening grouting material involved in the invention. In the sections with better integrity of rock mass and less prone to large deformation disaster, ordinary grouting material is suggested for anchor rod, so that the project cost is reduced to the greatest extent on the premise of ensuring the stability of tunnel structures, and the safety and economy of project construction are achieved.

Compared with an existing grouting material, the grouting material in the invention has the characteristics that the water-binder ratio is 0.46:1, the ratio of the mass of the quick-hardening sulphoaluminate gelling agent to the mass of the ordinary Portland cement is (0.67-1.5): 1, and the grouting material has the advantages of simple components, remarkable effects, simplicity and convenience in on-site implementation and the like, and has the following excellent properties:

(1) High strength and quick-hardening properties: 4 h compressive strength is higher than 10 MPa; according to the characteristics of large deformation disasters in weak, loose and broken stratum tunnels, the high strength and quick-hardening properties of stratum grouting reinforcement and anchor rod grouting reinforcement are fully realized, reinforcement and suspension effects of the anchor rod can be effectively exerted in time, and through the on-site practical application of the grouting material in the Muzhailing tunnel of Weiyuan-Wudu expressway in China, the effect is quite remarkable.

(2) Good fluidity: the initial setting time is 40±5 min, and the grouting material is simple and practical and is easy to operate. According to the grouting material provided by the invention, the quick-hardening sulphoaluminate gelling agent and the ordinary Portland cement are used as gelling materials, by the quick-hardening sulphoaluminate gelling agent, purposes of early strength and quick hardening are achieved, the ordinary Portland cement replaces a retarder to control the flow and setting time of grout, meanwhile, the use amount of the quick-hardening sulphoaluminate gelling agent can be greatly reduced by adding the ordinary Portland cement, and the economy is remarkable; material feeding and mixing are implemented simply in a tunnel on site, the operability is high, and the batching accuracy and the grouting efficiency can be greatly improved.

(3) The penetrability is good, and the concretion rate is high. The grouting material involved in the invention can be fully pressed into the joint cracks of the surrounding rocks, the concretion rate is high, and an effect of reinforcing the surrounding rocks can be effectively achieved.

(4) Any external admixture is not needed, and the grouting material is easy to prepare, and simple and convenient to implement on site.

Aiming at preventing a large deformation disaster occurring in the construction process of a tunnel in a weak and loose stratum, an economical high-strength quick-hardening tunnel grouting material is newly prepared by combining two kinds of cements with different properties. In the grouting material, the property advantages of the two kinds of cements are fully utilized, components are simple, the external admixture is not needed, and the grouting is simple and convenient to operate when used on site. The practical application of an outdoor side slope test and an in-tunnel field test showed the effect is quite remarkable, and large deformation disasters such as concrete cracking, spalling, steel frame distortion, breaking and initial support intrusion are effectively controlled, and the grouting material can be widely applied. In selection of grouting pressure parameters, the anchor holes and the rod bodies are filled with the grout under small grouting pressure (less than 1.0 MPa) for feet-lock pipes, high holding force can be provided rapidly, the pulling resistance of the anchor rods and the strength and rigidity of the anchor rods are improved, the grouting pressure (higher than or equal to 1.0 MPa) is selected for the advanced grouting guide pipe and the circumferential radial grouting guide pipe, under the action of a thick grout stopping and sealing layer, the grout can be pressed into the joint cracks of the soft and loose surrounding rocks to rapidly form a reinforcing ring, and the cohesion of the surrounding rocks and the integrity of the rock mass are improved.

### BRIEF DESCRIPTION OF THE DRAWINGS

FIG. 1 is a schematic view showing the compressive strength of a grouting material of the invention with different ages.

FIG. 2 is a schematic view showing the flexural strength of the grouting material of the invention with different ages.

### DETAILED DESCRIPTION OF THE EMBODIMENTS

In order that the technical problems to be solved, technical schemes and beneficial effects in the invention can be more clearly understood, the invention will be described in further detail with reference to the figures and tables. It is to be understood that the specific embodiments described herein are merely illustrative of the invention and are not intended to be limiting thereof.

In the invention, ordinary Portland cement and a quick-hardening sulphoaluminate gelling agent are selected as raw materials for proportioning of grout. The high-strength quick-hardening grouting material convenient to construct is optimized and prepared through a single-factor control test and a durability strength test, in combination with grouting parameters obtained through an indoor anchoring grouting mix ratio test, an optimization test is carried out, the Muzhailing tunnel of the expressway project in China is taken as an example to practically use the grouting material.

The economical high-strength quick-hardening grouting material of the invention includes the ordinary Portland cement, the quick-hardening sulphoaluminate gelling agent and water, wherein the ratio of the mass of the water to the sum of the mass of the ordinary Portland cement and the mass of the quick-hardening sulphoaluminate gelling agent is 0.46:1, and the ratio of the mass of the quick-hardening sulphoaluminate gelling agent to the mass of the ordinary Portland cement is (0.67-1.5): 1. The quick-hardening sulphoaluminate gelling agent is quick-hardening sulphoaluminate 425 # cement.

Preferably, the ratio of the mass of the quick-hardening sulphoaluminate gelling agent to the mass of the ordinary Portland cement is 2:3.

Preferably, the ratio of the mass of the quick-hardening sulphoaluminate gelling agent to the mass of the ordinary Portland cement is 1:1.

Preferably, the ratio of the mass of the quick-hardening sulphoaluminate gelling agent to the mass of the ordinary Portland cement is 3:2.

A preparation method of the high-strength quick-hardening grouting material includes the steps of uniformly mixing the quick-hardening sulphoaluminate gelling agent with the ordinary Portland cement according to a proportion, adding water and then carrying out uniform mixing, wherein the ratio of the mass of the water to the mass of the quick-hardening sulphoaluminate gelling agent is 0.46:1, and the ratio of the mass of the quick-hardening sulphoaluminate gelling agent to the mass of the ordinary Portland cement is (0.67-1.5): 1.

### Embodiment 1

An economical high-strength quick-hardening grouting material includes ordinary Portland cement, a quick-hardening sulphoaluminate gelling agent and water. The water-binder ratio is 0.46:1, the ratio of the mass of the quick-hardening sulphoaluminate gelling agent to the mass of the ordinary Portland cement is 0.67:1, and the grouting material prepared by adopting the ratio can meet the requirement of bearing strength required for grouting a weak carbonaceous phyllite sandwiched thin-layer calcium-siliceous sandy slate.

### Embodiment 2

An economical high-strength quick-hardening grouting material includes ordinary Portland cement, a quick-hardening sulphoaluminate gelling agent and water. The water-binder ratio is 0.46:1, the ratio of the mass of the quick-hardening sulphoaluminate gelling agent to the mass of the ordinary Portland cement is 1:1, and the grouting material prepared by adopting the ratio can meet the requirement of bearing strength required for grouting the weak carbonaceous phyllite sandwiched thin-layer calcium-siliceous sandy slate.

### Embodiment 3

An economical high-strength quick-hardening grouting material includes ordinary Portland cement, a quick-hardening sulphoaluminate gelling agent and water. The water-binder ratio is 0.46:1, the ratio of the mass of the quick-hardening sulphoaluminate gelling agent to the mass of the ordinary Portland cement is 1.5:1, and the grouting material prepared by adopting the ratio can meet the requirement of bearing strength required for grouting the weak carbonaceous phyllite sandwiched thin-layer calcium-siliceous sandy slate.

According to the preparation method of the grouting material, the quick-hardening sulphoaluminate gelling agent and the ordinary Portland cement are uniformly mixed according to the proportion, then water is added and uniform mixing is conducted. The water-binder ratio is 0.46, and the ratio of the mass of the quick-hardening sulphoaluminate gelling agent to the mass of the ordinary Portland cement is (0.67-1.5): 1.

Furthermore, the grouting parameters obtained in combination with the indoor anchoring grouting mix ratio test are shown in table 1, the side length of a test piece is 40 mm, the span is 100 mm, and the loading speed is 50 N/S.

TABLE 1
Mix Ratio Test Data for New Grouting Material of the Invention

| | Mix ratio | | | | | | Strength (Mpa) | | | | | |
|---|---|---|---|---|---|---|---|---|---|---|---|---|
| | | Cement (C) | | | | | 3 h | | 4 h | | 5 h | |
| | | | Quick- | Test requirements | | | Com- | | Com- | | Com- | |
| | | Ordinary | hardening | Indoor | Water | | pressive | | pressive | | pressive | |
| | Water | Portland | sulphoaluminate | temperature | temperature | Setting | resist | Flexural | resist | Flexural | resist | Flexural |
| Embodiment | (W) | cement | [symbol] | (° C.) | (° C.) | time | [symbol] | strength | [symbol] | strength | [symbol] | strength |
| 1 | 0.46 | 0.4 | 0.6 | 22.3 | 14 | 36 | 13 | 4.4 | 13.7 | 4.8 | 16.9 | 4.3 |
| | 828 g | 720 g | 1080 g | | | | | | | | | |
| 2 | 0.46 | 0.5 | 0.5 | 22.5 | 14 | 37 | 16.6 | 3.4 | 19.2 | 6.4 | 20.1 | 6.1 |
| | 828 g | 900 g | 900 g | | | | | | | | | |
| 3 | 0.46 | 0.6 | 0.4 | 22.4 | 14.5 | 38 | 9.4 | 3.1 | 12.6 | 4.1 | 14.8 | 4 |
| | 828 g | 1080 g | 720 g | | | | | | | | | |

[symbol]

indicates data missing or illegible when filed

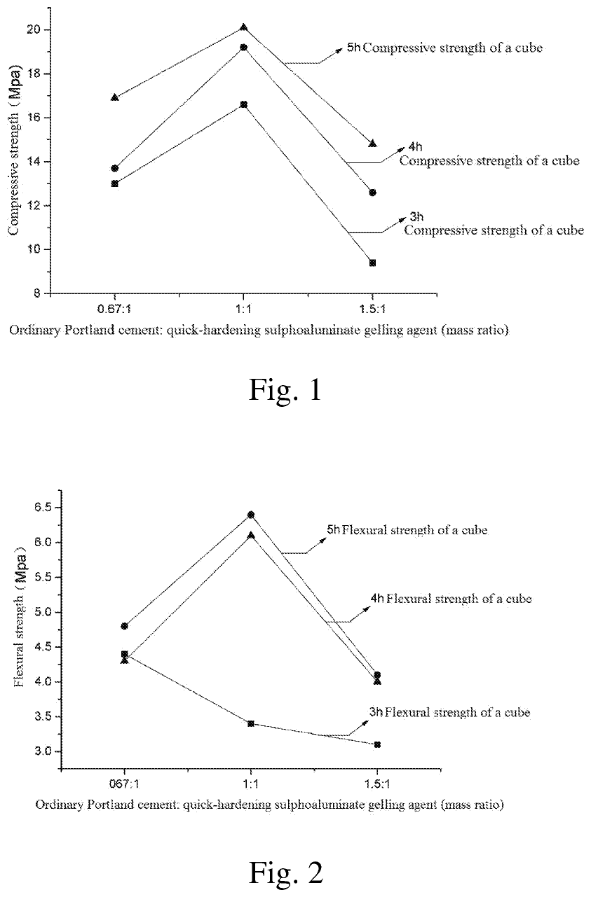

As can be seen from table 1, FIG. 1 and FIG. 2, the setting time of the grouting materials with the same mix ratio (W/C=0.46) is prolonged with the increase of the content of the ordinary cement, and the compressive strength of test pieces can reach 10 MPa or above 4 hours later, and the compressive strength of the test pieces gradually stabilizes with the increase in time. In addition, by adjusting the ratio of the quick-hardening sulphoaluminate gelling agent to the ordinary Portland cement, three kinds of grouts which are optimized and screened out can meet two indexes of fluidity as well as high strength and quick hardening.

The mix ratio of the embodiment 3 is selected to conduct a sampling test on site, the specification of the test pieces is 70.7 mm*70.7 mm*70.7 mm, a mechanical stirring mode is adopted, the model of a pressure testing machine is HYZ-300.10, the loading speed is 1.3 kN/S, and the test results are shown in Table 2.

TABLE 2
On-site Sampling Strength Test Record of Grouting
Material With Mix Ratio in Embodiment 3

| | | | Maintenance | |
|---|---|---|---|---|
| | Outdoor | Grout | temperature/ | 28 d compressive |
| | temperature | temperature | humidity | strength average |
| Age | (DEG C.) | (DEG C.) | (DEG C./% RH) | value (MPa) |
| 3 h | 20.5 | 19 | 20/90 | 15.4 |
| 4 h | 20.5 | 19 | 20/90 | 16.4 |
| 7 d | 20.5 | 19 | 20/90 | 28.7 |
| 14 d | 20.5 | 19 | 20/90 | 32 |
| 28 d | 20.5 | 19 | 20/90 | 30 |

As can be seen from table 2, in the on-site sampling test of the grouting material with the mix ratio in the embodiment 3, the compressive strength of the grouting material is increased with the increase in the maintenance time of the test pieces, and the compressive strength of 30 MPa can be achieved at 28 d. It should be noted that calculation for the average compressive strength of the test pieces adopts the following way: if one of six measured values exceeds six average values by ±10%, the data are deleted, and the remaining average compressive strength is taken as final average data; and if recorded data exceeding the average value by ±10% still exist in the remaining five test values, the test result of the test piece is discarded.

The grouting and pull-out tests for anchor rods of a side slope are carried out by adopting the grouting material with the mix ratio of the embodiment 3, and the test results are listed in table 3.

TABLE 3
Pull-out Test Results of Anchor Rod

| | | | | | Anchoring |
|---|---|---|---|---|---|
| Number of | | Diameter | Length | | force |
| anchor rod | Grout type | (mm) | (cm) | Age | (kN) |
| 1 | Ordinary Portland | Φ42 | 400 | 7 d | 64 |
| | cement paste | | | | |
| 2 | Embodiment 3 | Φ57 | 300 | 4 h | 232 |
| 3 | Embodiment 3 | Φ57 | 400 | 4 h | 259 |
| 4 | Embodiment 3 | Φ57 | 600 | 4 h | 309 |
| 5 | Embodiment 3 | Φ76 | 500 | 4 h | 399 |
| 6 | Embodiment 3 | Φ76 | 600 | 4 h | 480 |
| 7 | Embodiment 3 | Φ76 | 700 | 4 h | 502 |

As shown in table 3, the anchoring effect of the new grouting material involved in the invention is far higher than that of frequently used ordinary Portland cement paste, and the drawing force of the new grouting material in 4 h age is about 4 times that of the ordinary Portland cement paste in 7 d age. Meanwhile, the anchoring force of the new grouting material is increased with the increase of the diameter and length of the anchor rods. Therefore, by the new grouting material involved in the invention, test purposes of high strength and quick hardening are achieved, the anchoring effect is quite remarkable, the requirement of project prevention and treatment of large deformation of soft rock tunnels is met, and the popularization and application value is remarkable due to simple and practical proportioning and high operability.

### Embodiment 4

An economical high-strength quick-hardening grouting material includes ordinary Portland cement, a quick-hardening sulphoaluminate gelling agent and water. The water-binder ratio is 0.46:1, and the ratio of the mass of the quick-hardening sulphoaluminate gelling agent to the mass of the ordinary Portland cement is 1.2:1

### Embodiment 5

An economical high-strength quick-hardening grouting material includes ordinary Portland cement, a quick-hardening sulphoaluminate gelling agent and water. The water-binder ratio is 0.46, and the ratio of the mass of the quick-hardening sulphoaluminate gelling agent to the mass of the ordinary Portland cement is 0.9:1.

### Embodiment 6

An economical high-strength quick-hardening grouting material includes ordinary Portland cement, a quick-hardening sulphoaluminate gelling agent and water. The water-binder ratio is 0.46:1, and the ratio of the mass of the quick-hardening sulphoaluminate gelling agent to the mass of the ordinary Portland cement is 0.8:1.

The properties of the grout are quite important for a tunnel grouting project, therefore, the time (about 4 h) of a process from application of anchor rods (pipes) (including grouting) of a tunnel to next cyclic blasting excavation is fully considered for the grouting requirement of a soft rock large deformation tunnel in combination with a tunnel construction process closely, the new grouting grout involved in the invention needs to provide high strength and anchoring force within 4 h (the laboratory index is as follows: the compressive strength is higher than 10 MPa), thus, in the process of construction disturbance (especially blasting vibration), a reinforcement ring can be formed on the surrounding rocks on the periphery of the tunnel, and a bearing arch is formed; meanwhile, the anchoring force of the anchor rods can play a role to give tensile force to a steel frame and sprayed concrete, the circumstances that settlement deformation of an initial support under the action of blasting vibration is prevented, and the initial support is separated from the surrounding rocks are prevented, and a space because of relaxation and traction deformation of the surrounding rocks is avoided. In addition, in view of the time (about 40 min) required for feeding, mixing, pumping and cleaning of grouting equipment in the on-site grouting process of the tunnel, the initial setting time of the grouting grout involved in the invention is required to be 40±5 min. Therefore, two qualitative and quantitative control indexes of the grouting material involved in the invention are as follows:

(1) high strength and quick hardness: 4 h compressive strength is higher than 10 MPa;

(2) good fluidity: the initial setting time is 40±5 min. The initial setting time is measured by a Vicat apparatus according to a national standard method.

Based on the two basic indexes, basic properties of various cements (Portland cement, ordinary Portland cement, fly ash Portland cement, composite Portland cement, sulphoaluminate cement, a quick-hardening sulphoaluminate gelling agent, ferric aluminate cement, expansive cement and the like), admixtures (fly ash and alunite) and additives (a water reducing agent, an early strength agent, a retarder and an expansive agent) are carefully investigated and analyzed at the beginning of the test, through a single factor test, an orthogonal test and an expansibility test, up to 500 groups of basic tests are carried out on various kinds of cements, and finally, the grouting material which is simple, easy to operate, high in strength, quick in hardening, economical, good in permeability and high in concretion rate and a mix ratio are optimized and screened. Finally, through outdoor slope and in-tunnel field tests, the practical application is carried out, the effect is extremely remarkable, the large deformation disasters such as concrete cracking, spalling, steel frame distortion, breaking, initial support invasion and the like of the soft rock tunnels are effectively controlled, and the grouting material can be widely applied to other tunnel projects, slope projects, hydraulic projects and foundation pit projects, and has extremely high popularization values.

The on-site implementation scheme of the grouting reinforcement material used for construction of the soft rock tunnels is introduced by taking a three-bench excavation method as an example:

(1) Upper Bench Construction

Firstly, an upper bench is excavated, initial spraying of early-strength concrete of 3-5 cm is carried out on an excavated surface after excavating a footage, and the spraying thickness of the initially sprayed concrete can be properly increased according to weathering, loosening and peeling degrees of surrounding rocks, and the initially sprayed concrete serves as a plugging layer for follow-up grouting work; secondly, steel frames of the upper bench are erected, the advanced grouting guide pipes, the circumferential radial grouting guide pipes and the feet-lock pipes can be applied in sequence or simultaneously according to on-site conditions, the grouting material in the invention is injected, and then a steel bar mesh is arranged in a hanging manner;

and finally, the concrete is sprayed again until the thickness reaches the designed thickness to form the initial supporting structure of the upper bench.

(2) Middle Bench Construction

Under the support of the initial supporting structure of the upper bench, middle bench is excavated on two sides in a staggered mode, core soil portion of the middle bench is reserved, initial spraying of early-strength concrete of 3-5 cm is carried out on the excavated surface after excavating a footage, the spraying thickness of the initially sprayed concrete can be properly increased according to the weathering, loosening and peeling degrees of surrounding rocks, and the initially sprayed concrete serves as a plugging layer for follow-up grouting work; then the steel frames of the middle bench are erected, the circumferential radial grouting guide pipes and the feet-lock pipes are applied in sequence or simultaneously according to the on-site condition, the grouting material of the invention is injected, and then a steel bar mesh is arranged in a hanging manner; and finally, concrete is sprayed again to the designed thickness to form the initial supporting structure of the middle bench.

(3) Lower Bench Construction

Lower bench is excavated on two sides in a staggered mode, core soil portions of the lower steps are reserved, initial spraying of early-strength concrete of 3-5 cm is carried out on an excavated surface after excavating a footage, the spraying thickness of the initially sprayed concrete can be properly increased according to the weathering, loosening and peeling degrees of surrounding rocks, and the initially sprayed concrete serves as a plugging layer for follow-up grouting work; then the steel frames of the lower bench are erected, the circumferential radial grouting guide pipes and the feet-lock pipes are applied in sequence or simultaneously according to the on-site condition, the grouting material of the invention is injected, and then a steel bar mesh is arranged in a hanging manner; and finally, concrete is sprayed again to the designed thickness to form the initial supporting structure of the lower bench.

Compared with a general grouting material (ordinary Portland cement paste) for tunnel projects, the grouting material provided by the invention has the following advantages and innovations:

(1) The grouting material has high strength and quick-hardening properties. According to the characteristics of large deformation disasters in weak, loose and broken stratum tunnels, the high-strength and quick-hardening property of stratum grouting reinforcement and anchor rod grouting reinforcement are fully realized, reinforcement and suspension effects of the anchor rod can be effectively exerted in time, and through the on-site practical application of the grouting material on the Muzhailing tunnel of the Weiyuan-Wudu expressway in China, the effect is quite remarkable.

(2) The grouting material is simple and practical and is easy to operate. According to the grouting material disclosed by the invention, the ordinary Portland cement and the quick-hardening sulphoaluminate gelling agent are used as gelling materials, the purpose of early strength and quick hardening is achieved through the quick-hardening sulphoaluminate gelling agent, and the flow time and setting time of grout are controlled through the ordinary Portland cement; on-site feeding and mixing in tunnels are simple, the operability is high, and the batching accuracy and the grouting efficiency can be greatly improved.

(3) The grouting material is high in penetrability and high in concretion rate. The grouting material disclosed by the invention can be fully pressed into the joint cracks of the surrounding rocks, the concretion rate is high, and an effect of reinforcing the surrounding rocks can be effectively achieved.

(4) The grouting material is economical and is suitable for popularization. Compared with other chemical grouts or pure quick-hardening sulphoaluminate gelling agent paste, the grouting material disclosed by the invention greatly saves the cost (or the amount of the quick-hardening sulphoaluminate gelling agent), is economical and is easy to popularize on the basis of realizing the purpose of early strength and quick hardening and accurately controlling the setting time of the grout by adding the ordinary Portland cement on the premise of meeting the requirements of tests and projects.

The foregoing content is a further detailed description of the method of the invention with reference to specific embodiments, to which specific embodiments of the method of the invention are not intended to be limiting. It will be apparent to those skilled in the art that various equivalents and modifications, with the same performance or use, without departing from the conception of the invention, shall be deemed to fall within the scope of protection established by the submitted claims.

1. An economical high-strength quick-hardening grouting material, wherein, comprising ordinary Portland cement, quick-hardening sulphoaluminate gelling agent and water, wherein the ratio of the mass of the water to the sum of the mass of the ordinary Portland cement and the mass of the quick-hardening sulphoaluminate gelling agent is 0.46:1, and the ratio of the mass of the quick-hardening sulphoaluminate gelling agent to the mass of the ordinary Portland cement is (0.67-1.5):1; and the initial setting time of the grouting reinforcement material is 40±5 min, and the average compressive strength of a cube solidified for 4 hours is higher than or equal to 10 MPa.

2. The economical high-strength quick-hardening grouting material according to claim 1, wherein, the quick-hardening sulphoaluminate gelling agent is quick-hardening sulphoaluminate 425# cement.

3. The economical high-strength quick-hardening grouting material according to claim 1, wherein, the ratio of the mass of the quick-hardening sulphoaluminate gelling agent to the mass of the ordinary Portland cement is (1-1.5):1.

4. The economical high-strength quick-hardening grouting material according to claim 1, wherein, the ratio of the mass of the quick-hardening sulphoaluminate gelling agent to the mass of the ordinary Portland cement is (0.67-1):1.

5. The economical high-strength quick-hardening grouting material according to claim 1, wherein, the ratio of the mass of the quick-hardening sulphoaluminate gelling agent to the mass of the ordinary Portland cement is (0.67-0.9): 1.

6. The economical high-strength quick-hardening grouting material according to claim 1, wherein, the ratio of the mass of the quick-hardening sulphoaluminate gelling agent to the mass of the ordinary Portland cement is 1.5:1.

7. A grouting reinforcement method for a soft rock tunnel, wherein: comprising the steps of initially spraying concrete, erecting steel frames, and reinforcing surrounding rocks through advanced grouting small guide pipes, circumferential radial guide pipes and feet-lock pipes after excavating one footage of the soft rock tunnel, wherein the advanced grouting small guide pipes, the circumferential radial guide pipes and the feet-lock pipes are filled with the economical high-strength quick-hardening grouting material of claim 1, the grouting pressure of the advanced grouting small guide pipes is 1.0-3.0 MPa, the grouting pressure of the circumferential radial guide pipes is 1.5-5.0 MPa, the grouting pressure of the feet-lock pipes is 0.5-1.0 MPa, and short-time long-interval excavation construction is realized.

8. The grouting reinforcement method for the soft rock tunnel according to claim 7, wherein, a mechanical and/or weak blasting construction method is adopted in excavation of the soft rock tunnel.

9. The economical high-strength quick-hardening grouting material according to claim 2, wherein, the ratio of the mass of the quick-hardening sulphoaluminate gelling agent to the mass of the ordinary Portland cement is (1-1.5): 1.

10. A grouting reinforcement method for a soft rock tunnel, wherein: comprising the steps of initially spraying concrete, erecting steel frames, and reinforcing surrounding rocks through advanced grouting small guide pipes, circumferential radial guide pipes and feet-lock pipes after excavating one footage of the soft rock tunnel, wherein the advanced grouting small guide pipes, the circumferential radial guide pipes and the feet-lock pipes are filled with the economical high-strength quick-hardening grouting material of claim 2, the grouting pressure of the advanced grouting small guide pipes is 1.0-3.0 MPa, the grouting pressure of the circumferential radial guide pipes is 1.5-5.0 MPa, the grouting pressure of the feet-lock pipes is 0.5-1.0 MPa, and short-time long-interval excavation construction is realized.

11. A grouting reinforcement method for a soft rock tunnel, wherein: comprising the steps of initially spraying concrete, erecting steel frames, and reinforcing surrounding rocks through advanced grouting small guide pipes, circumferential radial guide pipes and feet-lock pipes after excavating one footage of the soft rock tunnel, wherein the advanced grouting small guide pipes, the circumferential radial guide pipes and the feet-lock pipes are filled with the economical high-strength quick-hardening grouting material of claim 3, the grouting pressure of the advanced grouting small guide pipes is 1.0-3.0 MPa, the grouting pressure of the circumferential radial guide pipes is 1.5-5.0 MPa, the grouting pressure of the feet-lock pipes is 0.5-1.0 MPa, and short-time long-interval excavation construction is realized.

12. A grouting reinforcement method for a soft rock tunnel, wherein: comprising the steps of initially spraying concrete, erecting steel frames, and reinforcing surrounding rocks through advanced grouting small guide pipes, circumferential radial guide pipes and feet-lock pipes after excavating one footage of the soft rock tunnel, wherein the advanced grouting small guide pipes, the circumferential radial guide pipes and the feet-lock pipes are filled with the economical high-strength quick-hardening grouting material of claim 4, the grouting pressure of the advanced grouting small guide pipes is 1.0-3.0 MPa, the grouting pressure of the circumferential radial guide pipes is 1.5-5.0 MPa, the grouting pressure of the feet-lock pipes is 0.5-1.0 MPa, and short-time long-interval excavation construction is realized.

13. A grouting reinforcement method for a soft rock tunnel, wherein: comprising the steps of initially spraying concrete, erecting steel frames, and reinforcing surrounding rocks through advanced grouting small guide pipes, circumferential radial guide pipes and feet-lock pipes after excavating one footage of the soft rock tunnel, wherein the advanced grouting small guide pipes, the circumferential radial guide pipes and the feet-lock pipes are filled with the economical high-strength quick-hardening grouting material of claim 5, the grouting pressure of the advanced grouting small guide pipes is 1.0-3.0 MPa, the grouting pressure of the circumferential radial guide pipes is 1.5-5.0 MPa, the grouting pressure of the feet-lock pipes is 0.5-1.0 MPa, and short-time long-interval excavation construction is realized.

14. A grouting reinforcement method for a soft rock tunnel, wherein: comprising the steps of initially spraying concrete, erecting steel frames, and reinforcing surrounding rocks through advanced grouting small guide pipes, circumferential radial guide pipes and feet-lock pipes after excavating one footage of the soft rock tunnel, wherein the advanced grouting small guide pipes, the circumferential radial guide pipes and the feet-lock pipes are filled with the economical high-strength quick-hardening grouting material of claim 6, the grouting pressure of the advanced grouting small guide pipes is 1.0-3.0 MPa, the grouting pressure of the circumferential radial guide pipes is 1.5-5.0 MPa, the grouting pressure of the feet-lock pipes is 0.5-1.0 MPa, and short-time long-interval excavation construction is realized.
